(19) United States
(12) Patent Application Publication
(10) Pub. No.: US 2025/0190944 A1
(43) Pub. Date: Jun. 12, 2025

(54) AUTOMATED STORAGE SYSTEM AND LOAD STORAGE METHOD

(71) Applicant: Murata Machinery, Ltd., Kyoto-shi, Kyoto (JP)

(72) Inventor: Jo Kuwata, Inuyama-shi, Aichi (JP)

(73) Assignee: Murata Machinery, Ltd., Kyoto-shi, Kyoto (JP)

(21) Appl. No.: 18/844,567

(22) PCT Filed: Feb. 7, 2023
(86) PCT No.: PCT/JP2023/003992

§ 371 Date: Sep. 6, 2024

(30) Foreign Application Priority Data
Mar. 16, 2022 (JP) 2022-040924

(51) Int. Cl. G06Q 10/0875

(52) U.S. Cl. CPC G06Q 10/0875

(57) ABSTRACT

An automated storage system includes: a group of automated storages; stations that receive loads carried out of the group of automated storages; one or more carriers that carry the loads from the group of automated storages to the stations; and a management device that determines storage positions of loads. The management device includes: a category information obtainer that obtains category information for categorizing loads into high-ranked products, middle-ranked products, and low-ranked products based on a load carrying frequency; a neighboring area information obtainer that obtains neighboring area information indicating neighboring areas in which loads categorized as the middle-ranked products are stored and each of which is close to a different one of the stations; and a storage information generator that generates storage information for dispersedly storing the loads categorized as the middle-ranked products in the neighboring areas based on the category information and the neighboring area information.

### CROSS REFERENCE TO RELATED APPLICATIONS

This application is a US national stage filing under 35 U.S.C. § 371 of International Application No. PCT/JP2023/003992, filed Feb. 7, 2023, which claims priority to Japanese Patent Application No. 2022-040924, filed Mar. 16, 2022, each of which is incorporated herein by reference in its entirety.

### TECHNICAL FIELD

This disclosure relates to an automated storage system for carrying loads from racks to stations using one or more carriers, and a load storage method thereof.

### BACKGROUND

Conventional automated storage systems with racks include an automated storage system that dispersedly stores loads in racks to enhance the efficiency of carrying the loads out of the racks (see Japanese Unexamined Patent Application Publication No. 2000-255720, for example). Moreover, Japanese Unexamined Patent Application Publication No. 2008-162747 describes an automated storage system that manages, for each load type, the frequency of carrying loads out of racks, and dispersedly stores products whose carrying frequency is low.

However, I found that loads whose carrying frequency is middle and thus whose stock is not enough to be dispersedly stored in all the racks, when their storage positions are determined according to the conventional procedure, the efficiency of carrying loads out of the racks decreases in the automated storage system as a whole.

It could therefore be helpful to provide an automated storage system that can efficiently carry loads out of racks even when the loads including loads whose carrying frequency is middle are stored in the racks, and a load storage method thereof.

### SUMMARY

Disclosed herein is an automated storage system including: a group of automated storages that store different types of loads; a plurality of stations that receive loads carried out of the group of automated storages; one or more carriers that carry the loads from the group of automated storages to the plurality of stations; and a management device that determines storage positions of the different types of loads in the automated storages, in which the management device includes: a category information obtainer that obtains category information for categorizing the different types of loads into high-ranked products, middle-ranked products, and low-ranked products on a load type basis based on a load carrying frequency; a neighboring area information obtainer that obtains neighboring area information indicating, in the group of automated storages, neighboring areas in which loads categorized as the middle-ranked products are stored and each of which is close to a different one of the plurality of stations; and a storage information generator that generates storage information for dispersedly storing loads categorized as the high-ranked products in the automated storages based on the category information and for dispersedly storing the loads categorized as the middle-ranked products in the neighboring areas based on the category information and the neighboring area information.

Also disclosed herein is a load storage method of an automated storage system including: a group of automated storages that store different types of loads; a plurality of stations that receive loads carried out of the group of automated storages; one or more carriers that carry the loads from the group of automated storages to the plurality of stations; and a management device that determines storage positions of the different types of loads in the automated storages. The load storage method includes: obtaining, by a category information obtainer, category information for categorizing the different types of loads into high-ranked products, middle-ranked products, and low-ranked products on a load type basis based on a load carrying frequency; obtaining, by a neighboring area information obtainer, neighboring area information indicating, in the group of automated storages, neighboring areas in which loads categorized as the middle-ranked products are stored and each of which is close to a different one of the plurality of stations; and generating, by a storage information generator, storage information for dispersedly storing loads categorized as the high-ranked products in the automated storages based on the category information and for dispersedly storing the loads categorized as the middle-ranked products in the neighboring areas based on the category information and the neighboring area information.

Even when different types of loads including loads whose load carrying frequency is categorized as the middle-ranked products are stored in racks, it is possible to efficiently carry the loads out of the racks.

### BRIEF DESCRIPTION OF THE DRAWINGS

FIG. 1 is a perspective view of an automated storage system.

FIG. 2 is a block diagram illustrating the functional configuration of a management device.

FIG. 3 is a diagram illustrating a schematic neighboring area.

### DETAILED DESCRIPTION

The following describes an example of an automated storage system with reference to the drawings. Note that the example described below is one example of my system and method for the sake of explanation, and therefore is not intended to limit the scope of this disclosure. For example, the shapes, configurations, materials, elements, relative positional relationships, connection states, numerical values, numerical expressions, contents of steps in a method, an order of the steps, etc., indicated in the following example are mere examples, and contents not described below may be included. Moreover, geometric expressions such as parallel and orthogonal may be used. These expressions do not necessarily provide mathematical strictness, and substantially include allowable errors, offsets, or the like. The expressions such as simultaneous and same also substantially include allowable margins.

Moreover, the drawings are schematic illustrations in which emphasis, omission, and ratio adjustment are made where necessary to illustrate an automated storage system in accordance with this disclosure. Accordingly, the shapes, positional relationships, and ratios of elements are different from the actual shapes, positional relationships, and ratios of the elements. Moreover, the X-axis, the Y-axis, and the Z-axis shown in the drawing indicate Cartesian coordinates optionally set for the explanation of the drawing. In other words, the Z-axis is not limited to the axis in the vertical direction, and the X-axis and the Y-axis are not limited to the axes present in the horizontal plane.

Moreover, the following may generically describe plural inventions as one example. Moreover, part of the contents described below is explained as optional elements related to this disclosure.

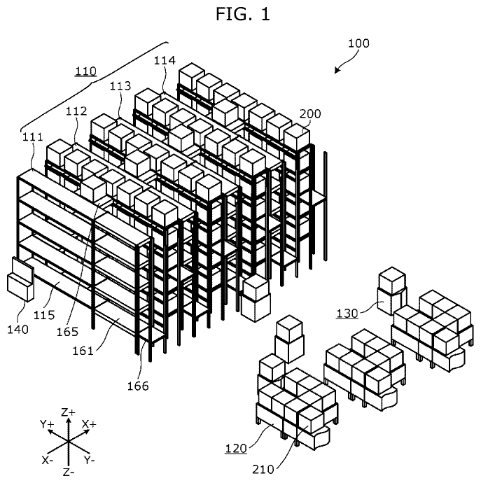

FIG. 1 is a perspective view of automated storage system 100.

As shown in FIG. 1, automated storage system 100 is a system for automatically carrying loads 200 out of storages, and includes group of automated storages 110, stations 120, carriers 130, and management device 140.

Group of automated storages 110 includes automated storages. Group of automated storages 110 includes, as the automated storages, first automated storage 111, second automated storage 112, third automated storage 113, and fourth automated storage 114. Note that the number of automated storages included in group of automated storages 110 is not limited to this. Moreover, the types or sizes (the allowable number of stored loads 200) of the automated storages may be different from each other.

First automated storage 111 is a storage for storing loads 200, into and out of which the loads are automatically carried. The types of the automated storages are not particularly limited. The automated storages each include racks 115, multilayer conveyors 161, carrier device 165, and vertical conveyors 166. Note that second automated storage 112, third automated storage 113, and fourth automated storage 114 also have the same configuration, and thus the detailed explanation is omitted.

Each of racks 115 is a shelf for storing loads 200. Each rack 115 includes shelf plates in a vertical direction (the Z-axis direction in FIG. 1), where each of the shelf plates holds loads 200 placed on the shelf plate and aligned in the first direction in a horizontal plane (the Y-axis direction in FIG. 1). Moreover, first automated storage 111 includes two parallel racks 115 between which carrier device 165 is sandwiched in the second direction orthogonal to the first direction in the horizontal plane (the X-axis direction in FIG. 1). Note that the length of rack 115 in the first direction is not particularly limited. In FIG. 1, the length of rack 115 is short. This is for the sake of simplifying the drawing, and thus at least one of actual racks 115 may be longer than the rack illustrated in FIG. 1.

Carrier device 165 is a device capable of transferring loads 200 held by racks 115 and multilayer conveyors 161 to different positions. The type of carrier device 165 is not particularly limited, and a stacker crane or the like can be taken as an example. Carrier device 165 includes rails each located at a different one of the levels corresponding to the shelf plates of racks 115 and travel vehicles each provided for a different one of the rails.

Each rail is a member disposed between two racks 115 and extending along rack 115 in the first direction to multilayer conveyor 161. Each travel vehicle moves back and forth along the corresponding rail with load 200 held by the travel vehicle. The travel vehicle includes a transfer device capable of transferring load 200 between the travel vehicle and each rack 115 and also between the travel vehicle and each multilayer conveyor 161. The transfer device can transfer load 200 between the travel vehicle and any of multilayer conveyors 161 and racks 115 on opposite sides of carrier device 165.

Multilayer conveyor 161 includes conveyors each located at a different one of the positions corresponding to the shelf plates of rack 115, and conveys load 200 along the first direction, i.e., the extending direction of racks 115, to transfer load 200 to vertical conveyor 166. Multilayer conveyor 161 also conveys load 200 transferred from vertical conveyor 166 to a predetermined position in multilayer conveyor 161. The type of multilayer conveyor 161 is not particularly limited, and a roller conveyor, a belt conveyor, or the like can be taken as an example. First automated storage 111 includes two parallel multilayer conveyors 161 between which carrier device 165 is sandwiched in the second direction orthogonal to the first direction in the horizontal plane (the X-axis direction in FIG. 1).

Vertical conveyor 166 includes a tray that goes up and down to the level corresponding to each layer of multilayer conveyor 161, and is capable of vertically (the Z-axis direction in FIG. 1) conveying load 200 transferred from a predetermined layer of multilayer conveyor 161 to transfer load 200 to and from carrier 130. First automated storage 111 includes two vertical conveyors 166 each corresponding to a different one of multilayer conveyors 161. Vertical conveyor 166 is also capable of transferring load 200 to and from carrier 130.

First automated storage 111 is connected to a loading conveyer (not shown). The loading conveyer is a conveyer for feeding load 200 to first automated storage 111. The loading conveyer branches to be connected to each of loading vertical conveyors 166 in the automated storages, i.e., first automated storage 111 to fourth automated storage 114, and management device 140 manages which automated storage load 200 is carried into.

Station 120 is an area for receiving load 200 carried out of any of the racks in group of automated storages 110. Station 120 is a picking station. In the picking station, a picking operation is performed in which a worker or a robot picks up a predetermined number of products specified by order from received load 200 and puts the picked products in container 210 for delivery. Load 200 from which the products have been removed is carried by carrier 130 from station 120 to group of automated storages 110, and stored in the rack again. Container 210 containing the products is shipped out from station 120 after the worker or the robot puts all the products of types specified by order in container 210.

Carrier 130 is a device that carries load 200 from group of automated storages 110 to station 120. The type of carrier 130 is not particularly limited as long as carrier 130 is a device capable of carrying load 200 from group of automated storages 110 to station 120. An unmanned carrying vehicle capable of autonomously travelling on the floor and including a transfer device capable of autonomously transferring load 200 is employed as carrier 130. Note that, although FIG. 1 shows the example in which load 200 is directly transferred between vertical conveyor 166 and carrier 130, load 200 may be transferred between vertical conveyor 166 and carrier 130 via a carrier device such as a chain conveyor. In this instance, carrier 130 may enter the carrier device and receive load 200 carried from vertical conveyor 166 by the carrier device by lifting up load 200, and may enter the carrier device and pass load 200 to the carrier device by lifting down load 200.

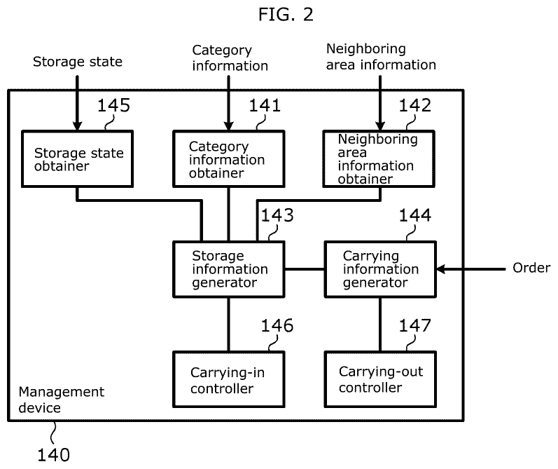

FIG. 2 is a block diagram illustrating a function unit of management device 140. Management device 140 is a device that determines the storage positions of loads 200 in the racks included in group of automated storages 110, and includes category information obtainer 141, neighboring area information obtainer 142, and storage information generator 143 as processing units for implementing the load storage method by causing a processor to execute a program. Management device 140 includes carrying information generator 144 and storage state obtainer 145.

Category information obtainer 141 obtains category information for categorizing loads 200 into high-ranked products, middle-ranked products, and low-ranked products on a load type basis based on a load carrying frequency indicating the frequency of carrying one or more loads 200 of each load type out of group of automated storages 110.

The category information refers to information for classifying loads 200 into groups each indicating a different load carrying frequency: high-ranked products; middle-ranked products; and low-ranked products. Loads 200 are grouped according to the type of contained product, and group of automated storages 110 stores as many loads 200 as the number corresponding to the load carrying frequency, each of which contains the same type of products (hereinafter also referred to as the “same load”) and whose load carrying frequency is high. Loads 200 categorized as the high-ranked products refer to loads 200 such that the same loads are stocked in group of automated storages 110 to be placed in almost all the automated storages (e.g., 90% or more of the total number of the automated storages) since the same loads are frequently carried out of group of automated storages 110. Automated storage system 100 includes four automated storages, and thus loads 200 such that four or more same loads are stocked are determined as the loads categorized as the high-ranked products. Loads 200 categorized as the middle-ranked products refer to loads 200 such that some same loads are stocked in group of automated storages 110, but cannot be placed in all the automated storages. Loads 200 such that two or three same loads are stocked in group of automated storages 110 are determined as the loads categorized as the middle-ranked products. Loads 200 categorized as the low-ranked products refer to loads 200 such that only one same load is stocked in group of automated storages 110. Note that the high-ranked products, the middle-ranked products, and the low-ranked products are defined based on the number of automated storages, but the present disclosure is not limited to this. For example, the high-ranked products, the middle-ranked products, and the low-ranked products may be defined based on the number of racks. Alternatively, the high-ranked products, the middle-ranked products, and the low-ranked products may be defined based on the load carrying frequency. For example, loads 200 carried out of group of automated storages 110 everyday are determined as loads 200 categorized as the high-ranked products, loads 200 carried out of group of automated storages 110 every 2 to 6 days are determined as loads 200 categorized as the middle-ranked products, and loads 200 carried out of group of automated storages 110 every 7 days or more are determined as loads 200 categorized as the low-ranked products. In when the high-ranked products, the middle-ranked products, and the low-ranked products are defined based on the number of racks, loads 200 such that eight or more same loads are stocked are categorized as the high-ranked products, loads 200 such that at least two and at most seven same loads are stocked are categorized as the middle-ranked products, and loads 200 such that one or two same loads are stocked are categorized as the low-ranked products.

The category information may be obtained by category information obtainer 141 counting the same loads every the same load is carried out of group of automated storages 110. Alternatively, for example, when automated storage system 100 is set up or when the stock status of loads 200 is remarkably changed due to the season or the like, the category information may be obtained from the upper controller or the like.

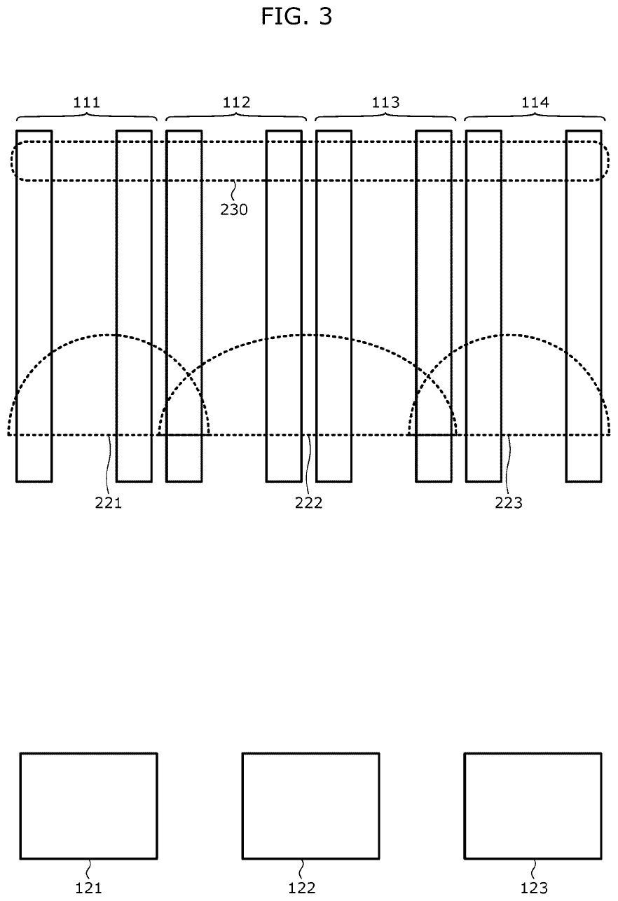

Neighboring area information obtainer 142 obtains neighboring area information indicating, in group of automated storages 110, neighboring areas in which loads 200 categorized as the middle-ranked products are stored and each of which is close to a different one of stations 120. The neighboring areas refer to areas in which loads 200 can be stored and areas each set for a different one of stations 120. For example, as shown in FIG. 3, when automated storage system 100 includes first station 121, second station 122, and third station 123, first neighboring area 221, second neighboring area 222, and third neighboring area 223 are set, respectively. The wording “close” means not close in terms of distance but short in terms of time from when carrier device 165 takes load 200 from the rack until carrier 130 delivers load 200 to station 120 (i.e., close in temporal distance). The wording “each of which is close to a different one” means that the temporal distance between first station 121 and first neighboring area 221 corresponding to first station 121 is shorter than the temporal distance between first station 121 and a neighboring area corresponding to a station other than first station 121 (second neighboring area 222 or third neighboring area 223). Note that the neighboring areas may overlap with each other. Moreover, the number of loads 200 disposed in each of the neighboring areas may be one or two or more. The neighboring area information may be obtained from the upper controller, or may be calculated by neighboring area information obtainer 142.

Storage information generator 143 dispersedly stores loads 200 categorized as the high-ranked products in the automated storages based on the category information obtained by category information obtainer 141. Loads 200 categorized as the high-ranked products may be dispersedly stored in racks 115 close to their respective stations since the load carrying frequency is high. Storage information generator 143 also generates storage information for dispersedly storing loads 200 categorized as the middle-ranked products in the neighboring areas based on the obtained category information and the neighboring area information obtained by neighboring area information obtainer 142. Storage information generator 143 generates storage information for storing loads 200 categorized as the low-ranked products in an area farther away from stations 120 than the neighboring areas are based on the category information and the neighboring area information. For example, storage information generator 143 generates storage information for storing loads 200 categorized as the low-ranked products in faraway area 230 shown in FIG. 3.

In particular, management device 140 includes storage state obtainer 145 that obtains, for each load 200 type, the storage state of loads 200 categorized as the middle-ranked products and stored in the neighboring areas, and storage information generator 143 generates storage information for storing load 200 in a neighboring area other than the neighboring areas in which loads 200 categorized as the middle-ranked products are already stored. For example, when loads 200 categorized as the middle-ranked products are already stored in first neighboring area 221 and second neighboring area 222, another load 200 categorized as the middle-ranked products is stored in third neighboring area 223.

When receiving an order indicating that load 200 categorized as the middle-ranked products and load 200 categorized as the high-ranked products are to be carried out of group of automated storages 110, carrying information generator 144 determines a neighboring area out of which load 200 categorized as the middle-ranked products is carried, and generates carrying information for carrying load 200 categorized as the high-ranked products out of the same automated storage as load 200 categorized as the middle-ranked products that is carried out of the determined neighboring area, or out of the automated storage as close to station 120 handling the order as possible. More specifically, for example, when one order includes both load 200 categorized as the middle-ranked products and load 200 categorized as the high-ranked products, carrying information generator 144 firstly determines the automated storage out of which load 200 categorized as the middle-ranked products is carried, and generates carrying information for carrying load 200 categorized as the high-ranked products out of the automated storage different from the determined automated storage. In this manner, load 200 categorized as the high-ranked products and load 200 categorized as the middle-ranked products to be carried to same station 120 can be carried simultaneously, and thus it is possible to prevent the occurrence of waiting for the picking operation.

Management device 140 includes carrying-in controller 146 that controls group of automated storages 110 and the like to store loads 200 carried into group of automated storages 110 in their respective predetermined neighboring areas, based on the generated storage information. Management device 140 also includes carrying-out controller 147 that performs the control to carry loads 200 out of group of automated storages 110, based on the carrying information generated by carrying information generator 144.

With automated storage system 100, loads 200 whose stock is not enough to be dispersedly stored in all the automated storages, i.e., loads 200 whose load carrying frequency is categorized as the middle-ranked products, are stored into the neighboring areas which are within easy access to stations 120, and thus it is possible to improve the carrying capacity of automated storage system 100 as a whole.

Moreover, loads 200 categorized as the low-ranked products are stored in an area farther away from the stations than the neighboring areas are, and thus it is possible to have a free space close to stations 120, thereby easily securing the neighboring areas.

Moreover, when load 200 categorized as the middle-ranked products is newly carried into group of automated storages 110, new load 200 is stored in a neighboring area other than the neighboring areas in which loads 200 categorized as the middle-ranked products are already stored, and thus it is possible to dispersedly storing loads 200 categorized as the middle-ranked products.

Note that this disclosure is not limited to the example described above. For example, other examples achieved by optionally combining the elements described in the specification or by excluding some of the elements may be implemented as an example of this disclosure. This disclosure encompasses variations obtained through various modifications made to the above example by a person skilled in the art within the scope of this disclosure, that is, within the meaning indicated by wordings used in the claims.

For example, although carrier device 165 and carrier 130 included in group of automated storages 110 are described as different devices, carrier 130 traveling on the floor may vertically move along the rack and travel on the rail provided at any of the shelf plates in the automated storage. Carrier 130 may be vertically moved by a vertical conveyor or the like regardless of with or without a load, or may be moved along a vertically extending rail by a motor included in carrier 130.

Moreover, although storage information generator 143 generates storage information for dispersedly storing loads 200 categorized as the middle-ranked products in the neighboring areas based on the neighboring area information obtained by neighboring area information obtainer 142, for example, storage information generator 143 may generate storage information for storing loads other than loads 200 categorized as the middle-ranked products in the neighboring areas according to the free-space state of racks 115. Moreover, in temporarily overlapping stocks or the like, storage information generator 143 may generate storage information for storing the middle-ranked products in an area other than the neighboring areas.

Moreover, although when the neighboring areas are fixedly set relative to stations 120 has been described as an example, the neighboring areas may be dynamically set according to the free-space state of racks 115 every time load 200 categorized as the middle-ranked products is carried into the group of automated storages.

Moreover, although automated storage system 100 including autonomously traveling vehicles as carriers 130 has been described as an example, automated storage system 100 may be provided with a carrier device such as a conveyer for transferring loads 200 between automated storages. In this instance, a conveyer connecting the automated storages and the picking stations may be employed as carriers 130.

### INDUSTRIAL APPLICABILITY

This disclosure is applicable to an automated storage in which loads stored in racks are carried to stations the number of which is less than the number of racks.

What is claimed is:

1. An automated storage system comprising: a group of automated storages that store different types of loads; a plurality of stations that receive loads carried out of the group of automated storages; one or more carriers that carry the loads from the group of automated storages to the plurality of stations; and a management device that determines storage positions of the different types of loads in the automated storages, wherein
the management device includes:
a category information obtainer that obtains category information for categorizing the different types of loads into high-ranked products, middle-ranked products, and low-ranked products on a load type basis based on a load carrying frequency;
a neighboring area information obtainer that obtains neighboring area information indicating, in the group of automated storages, neighboring areas in which loads categorized as the middle-ranked products are stored and each of which is close to a different one of the plurality of stations; and
a storage information generator that generates storage information for dispersedly storing loads categorized as the high-ranked products in the automated storages based on the category information and for dispersedly storing the loads categorized as the middle-ranked products in the neighboring areas based on the category information and the neighboring area information.

2. The automated storage system according to claim 1, wherein
the storage information generator generates storage information for storing loads categorized as the low-ranked products in an area farther away from the stations than the neighboring areas are based on the category information and the neighboring area information.

3. The automated storage system according to claim 1, wherein
the management device further includes:
a carrying information generator that, when receiving an order indicating that a load categorized as the middle-ranked products and a load categorized as the high-ranked products are to be carried out of the group of automated storages, generates carrying information by determining a neighboring area among the neighboring areas out of which the load categorized as the middle-ranked products is carried, and by determining the load categorized as the high-ranked products that is included in the order and carried out of the group of automated storages simultaneously with the load categorized as the middle-ranked products that is carried out of the neighboring area determined.

4. The automated storage system according to claim 1, wherein
the management device further includes:
a storage state obtainer that obtains a storage state of the loads categorized as the middle-ranked products and stored in the neighboring areas, and
the storage information generator generates storage information for storing a load in a neighboring area other than neighboring areas among the neighboring areas in which the loads categorized as the middle-ranked products are already stored.

5. A load storage method of an automated storage system including: a group of automated storages that store different types of loads; a plurality of stations that receive loads carried out of the group of automated storages; one or more carriers that carry the loads from the group of automated storages to the plurality of stations; and a management device that determines storage positions of the different types of loads in the automated storages, the load storage method comprising:
obtaining, by a category information obtainer, category information for categorizing the different types of loads into high-ranked products, middle-ranked products, and low-ranked products on a load type basis based on a load carrying frequency;
obtaining, by a neighboring area information obtainer, neighboring area information indicating, in the group of automated storages, neighboring areas in which loads categorized as the middle-ranked products are stored and each of which is close to a different one of the plurality of stations; and
generating, by a storage information generator, storage information for dispersedly storing loads categorized as the high-ranked products in the automated storages based on the category information and for dispersedly storing the loads categorized as the middle-ranked products in the neighboring areas based on the category information and the neighboring area information.
